(19) United States
(12) Patent Application Publication
(10) Pub. No.: US 2025/0222437 A1
(43) Pub. Date: Jul. 10, 2025

(54) CATALYST IN WHICH A SITE IS DOPED WITH CA/SR, A’ SITE IS DOPED WITH LA/Y, AND TI SITE IS DOPED WITH RU IN A PEROVSKITE A1-YA’YTI1-XRUXO3 STRUCTURE, MANUFACTURING METHOD THEREOF, AND DRY REFORMING METHOD USING THE SAME

(71) Applicant: KOREA INSTITUTE OF SCIENCE AND TECHNOLOGY, Seoul (KR)

(72) Inventors: Sung Pil YOON, Seoul (KR); Suk Woo Nam, Seoul (KR); Sun-Hee Choi, Seoul (KR); Seong Cheol Jang, Seoul (KR); Yong Min Kim, Seoul (KR); Hyuntae Sohn, Seoul (KR)

(21) Appl. No.: 19/001,963

(22) Filed: Dec. 26, 2024

(30) Foreign Application Priority Data
Jan. 5, 2024 (KR) 10-2024-0001904

(51) Int. Cl. B01J 23/63; B01J 23/46; B01J 35/00; B01J 35/70; B01J 37/08

(52) U.S. Cl. CPC B01J 23/63; B01J 23/462; B01J 35/19; B01J 35/733; B01J 37/08

(57) ABSTRACT

The present application discloses a catalyst with a perovskite structure, a method for preparing the same, and a dry reforming method using the same. The catalyst is represented by A_{1-y}A′_{y}Ti₁₋ₓRuₓO₃ and includes Ru nanoparticles exsoluted onto the catalyst surface. In the formula, A is Sr, Ca, or a combination thereof, A′ is La, Y, or a combination thereof, x is greater than 0 and less than or equal to 0.5, and y is greater than 0 and less than 1.0. The catalyst has the effect of maximizing the conversion rates of methane and carbon dioxide by maximizing the active sites for dry reforming reaction as well as thermal stability.

### DESCRIPTION OF GOVERNMENT-SPONSORED RESEARCH

The research was conducted at the Korea Institute of Science and Technology under the management of the Korea Institute of Science and Technology under the Ministry of Science and ICT. The research project name is the research operation expense support (main project expense) of the Korea Institute of Science and Technology, and the research project name is development of green hydrogen production-liquid storage integration technology (Project Unique Number: 1711196511, Project Number: 2E32460).

In addition, the research was conducted at the Korea Institute of Science and Technology under the management of the Korea Institute of Energy Technology Evaluation and Planning under the Ministry of Trade, Industry and Energy. The research project name is development of new and renewable energy core technology (electricity), and the research project name is development of a 1 kW-class molten carbonate type high-temperature electrolysis cell (MCEC) prototype (Project Unique Number: 1415186453, Project Number: 20213030040080).

### CROSS REFERENCE TO RELATED APPLICATION

The present application claims priority to Korean Patent Application No. 10-2024-0001904, filed on Jan. 5, 2024, the entire contents of which are incorporated herein for all purposes by this reference.

### BACKGROUND OF THE INVENTION

### Field of the Invention

The present disclosure discloses a catalyst with a perovskite structure, a method for manufacturing the same, and a dry reforming method using the same.

### Description of the Related Art

Dry reforming of methane is a promising route to convert carbon dioxide and methane into valuable synthesis gas (syn gas), which can be further converted into other useful chemicals or fuels. The commercialization success of this dry reforming process largely depends on the development of effective catalysts that can promote the desired reactions while suppressing undesirable reactions.

Dry reforming catalysts offer several attractive advantages for industrial applications. First, the dry reforming process can effectively convert carbon dioxide and methane into syn gas, which can be used as a feedstock for chemical and fuel production. Second, it is more environmentally friendly than the conventional steam reforming process because it can help reduce greenhouse gas emissions by utilizing carbon dioxide as a feedstock. Third, unlike the conventional steam reforming process, the dry reforming process does not use water, so it is energy efficient because the process of heating water and supplying it as steam can be eliminated. In particular, when applied to fuel cell power generation, the dry reforming process is an environmentally friendly reforming method that can produce hydrogen without using water even in water-scarce countries such as the Middle East and produce/supply water as a byproduct.

As such, dry reforming catalysts have many potential advantages, but they also have some disadvantages to consider. First, the biggest problem with dry reforming catalysts is that they are prone to deactivation due to carbon deposition, sintering, and other factors, which can reduce catalyst activity and selectivity, and require frequent catalyst regeneration or replacement, which reduces industrial productivity. Second, the performance of dry reforming catalysts is easily affected by impurities in the feedstock, such as sulfur, halides, and other contaminants, which contaminate the catalyst and cause a decrease in activity, selectivity, and stability of the catalysts. Third, some precious metal-based dry reforming catalysts have high material costs, which may limit their practicality for large-scale industrial applications. Therefore, it is necessary to minimize the use of precious metal materials and improve the catalyst life to reduce the catalyst cost required for the dry reforming process.

Conventionally known dry reforming catalysts can be largely classified into conventional metal-based catalysts and non-metal-based catalysts. In particular, metal-based catalysts such as nickel and cobalt have been extensively studied and used in the past, but they have several disadvantages such as carbon deposition, deactivation, and low selectivity. Recently, non-metal-based catalysts such as ceria-based material have emerged as promising alternative catalyst materials due to their high oxygen storage capacity and redox properties. However, the biggest problems of dry reforming catalysts, such as carbon deposition and decreased thermal stability, are fundamental causes that make demonstration operations for hundreds of hours or more impossible. Accordingly, despite various modifications to the strategy, such as transition metal doping and morphology control, basic data for more than 1,000 hours for commercialization have not yet been secured.

Dry reforming catalysts have made significant progress in recent years and offer several strengths and advantages for industrial applications. The development of effective and sustainable catalysts can enable the utilization of waste carbon dioxide streams and diversify feedstock options for chemical and fuel production. Therefore, dry reforming, which is a representative Carbon Capture Utilization & Storage (CCUS) technology that utilizes carbon dioxide, requires additional research and development to overcome the above-described problems in order to optimize catalyst performance and improve process stability and efficiency.

### SUMMARY OF THE INVENTION

In one aspect, an object of the present disclosure is to provide a catalyst with a perovskite structure that has excellent catalytic activity and effects of suppressing carbon deposition and enhancing thermal stability.

In another aspect, an object of the present disclosure is to provide a method for manufacturing the catalyst with the perovskite structure.

In another aspect, an object of the present disclosure is to provide a dry reforming method using the catalyst with the perovskite structure.

In one aspect, the present disclosure provides a catalyst with a perovskite structure, which is represented by Chemical Formula 1, and includes Ru nanoparticle exsoluted onto a surface of the catalyst.

A_{1-y}A′_{y}Ti₁₋ₓRuₓO₃ [Chemical Formula 1]

In the Chemical Formula 1, A is Sr, Ca, or a combination thereof, A′ is La, Y, or a combination thereof, x is greater than 0 and less than or equal to 0.5, and y is greater than 0 and less than 1.0.

In an exemplary embodiment, the catalyst may be a single phase homogeneous catalyst represented by the Chemical Formula 1.

In an exemplary embodiment, the exsoluted Ru nanoparticle may be formed by heat-treating a single phase homogeneous catalyst represented by the Chemical Formula 1 at 600 to 1,200° C. under a reducing atmosphere.

In an exemplary embodiment, the catalyst may contain 0.1 to 50% by weight of Ru based on the total weight of the catalyst.

In an exemplary embodiment, in the Chemical Formula 1, A may be Sr and A′ may be La, or A may be Ca and A′ may be Y.

In an exemplary embodiment, in the Chemical Formula 1, x may be greater than 0 and less than or equal to 0.3, and y may be greater than 0 and less than or equal to 0.5.

In an exemplary embodiment, the catalyst may be for dry reforming of methane and/or carbon dioxide.

In another aspect, the present disclosure provides a method for manufacturing the catalyst with the perovskite structure, comprising preparing a mixture of a metal precursor solution; drying and calcining the mixture; and heat-treating the mixture under a reducing atmosphere at 600 to 1,200° C. after the calcination.

In an exemplary embodiment, the drying may be performed at 70 to 90° C. for 60 to 180 minutes.

In an exemplary embodiment, the calcination may be performed at 600 to 800° C. for 60 to 180 minutes.

In an exemplary embodiment, the heat treatment for exsolution of nanoparticles after the calcination may be performed under a reducing atmosphere of 600 to 1,200° C. for 60 to 600 minutes.

In still another aspect, the present disclosure provides a dry reforming method using the catalyst with the perovskite structure, the method comprising supplying a reaction raw material gas containing methane and/or carbon dioxide to a reactor including the catalyst with the perovskite structure to perform a dry reforming reaction.

In an exemplary embodiment, the reaction raw material gas may be a mixture of methane and carbon dioxide in a molar ratio of 1:1 or more.

In one aspect, the technology disclosed in the present disclosure has the effect of providing a catalyst with a perovskite structure with excellent catalytic activity and effects of suppressing carbon deposition and enhancing thermal stability. The catalyst formed (exsolution) with Ru nanoparticles on the surface of the perovskite has the characteristics of high activity, suppressing carbon deposition, and maintaining high reaction activity for a long time due to high thermal stability compared to conventional catalysts. These characteristics enable it to overcome the weak carbon deposition suppression ability and thermal stability, which are the biggest problems of dry reforming, and thus it can become a key catalyst material essential for the synthesis gas production and carbon dioxide reduction process.

In another aspect, the technology disclosed in the present disclosure has the effect of providing a method for manufacturing the catalyst with the perovskite structure.

In another aspect, the technology disclosed in the present disclosure has the effect of providing a method for manufacturing a catalyst having the characteristic of maximally exsoluting Ru nanoparticles by forming Ca/Sr at the A site and La/Y at the A′ site in the perovskite A_{1-y}A′_{y}Ti₁₋ₓRuₓO₃ structure.

In another aspect, the technology disclosed in the present disclosure has the effect of providing a dry reforming method using the catalyst with the perovskite structure.

### BRIEF DESCRIPTION OF THE DRAWINGS

FIG. 1 shows the XRD analysis results of the catalyst of Example 1 after calcination at 650° C. (upper graph) and after exsolution process under a reducing atmosphere at 900° C. for 2 hours (lower graph) (upper: before exsolution, lower: after exsolution). In FIG. 1, the x-axis is 20 (degrees), and the y-axis is peak intensity (arbitrary units).

FIG. 2 shows the XRD analysis results of the catalyst of Example 2 after calcination at 650° C. (upper graph) and after exsolution process under a reducing atmosphere at 900° C. for 2 hours (lower graph) (upper: before exsolution, lower: after exsolution). In FIG. 2, the x-axis is 20 (degrees), and the y-axis is peak intensity (arbitrary units).

FIG. 3 shows the XRD analysis results of the catalyst of Comparative Example 1 after calcination at 650° C. (upper graph) and after exsolution process for 2 hours under a reducing atmosphere at 900° C. (lower graph), respectively (upper: before exsolution, lower: after exsolution). In FIG. 3, the x-axis is 20 (degrees) and the y-axis is peak intensity (arbitrary unit).

FIG. 4 shows the XRD analysis results of the catalyst of Comparative Example 2 after calcination at 650° C. In FIG. 4, the x-axis is 20 (degrees) and the y-axis is peak intensity (arbitrary unit).

FIG. 5 shows TEM images of the catalysts according to Examples and Comparative Examples after high-temperature reduction treatment. TEM images after the exsolution process for 2 hours at 900° C. under a reducing atmosphere for the catalysts of Comparative Example 1, Example 1, Example 2, Comparative Example 2, Comparative Example 3, and Comparative Example 4, respectively.

FIG. 6 shows a conversion rate (%) of methane by temperature during dry reforming operation after the reduction treatment of the catalyst (reaction conditions CH₄:CO₂:N₂=20:20:40, WHSV 120 L/(h·g_{cat}) N₂ excluded). The results are for the catalysts of Example 1, Example 2, Comparative Example 1, Comparative Example 2, Comparative Example 3, and Comparative Example 4, respectively.

FIG. 7 shows a conversion rate (%) of carbon dioxide by temperature during dry reforming operation after the reduction treatment of the catalyst (reaction conditions CH₄:CO₂:N₂=20:20:40, WHSV 120 L/(h·g_{cat}) N₂ excluded). These are the results for the catalysts of Example 1, Example 2, Comparative Example 1, Comparative Example 2, Comparative Example 3, and Comparative Example 4, respectively.

FIG. 8 shows a conversion rate (%) of methane according to an operation time (h) during long-term dry reforming operation after reduction treatment of the catalyst (reaction conditions CH₄:CO₂:N₂=20:20:40, 700° C., WHSV 120 L/(h·g_{cat}) N₂ excluded).

### DETAILED DESCRIPTION OF THE INVENTION

Hereinafter, the present disclosure will be described in detail.

In one aspect, the present disclosure provides a catalyst with a perovskite structure, wherein the catalyst is represented by Chemical Formula 1, and includes Ru nanoparticle exsoluted on the surface of the catalyst.

A_{1-y}A′_{y}Ti₁₋ₓRuₓO₃ [Chemical Formula 1]

In the above formula, A is Sr, Ca, or a combination thereof, A′ is La, Y, or a combination thereof, x is greater than 0 and less than or equal to 0.5, and y is greater than 0 and less than 1.0.

In an exemplary embodiment, the catalyst may be a single phase homogeneous catalyst represented by Chemical Formula 1.

In an exemplary embodiment, the exsoluted Ru nanoparticle may be formed by heat-treating a single phase homogeneous catalyst represented by Chemical Formula 1 at 600 to 1,200° C. under a reducing atmosphere. The catalyst includes a plurality of Ru nanoparticles exsoluted on the surface, and thus has the effect of significantly improving catalytic activity and thermal stability and enhancing resistance to carbon deposition.

The homogeneous catalyst refers to a structure in which an active material that is substituted within a material lattice is included to maintain a single phase. While conventional general catalysts are so-called heterogeneous catalysts that are composed of two or more phases by loading an active material on a support and performing heat treatment, the catalyst according to the present disclosure is a catalyst having a structure in which a homogeneous catalyst of a single phase is manufactured and then the catalytic active material is exsoluted in the form of nanoparticles on the surface. That is, in the perovskite A_{1-y}A′_{y}Ti₁₋ₓRuₓO₃ structure, since some of the A sites are doped (substituted) with A′ and some of the Ti sites are doped (substituted) with Ru, the basic perovskite structure can be maintained and a single phase can be achieved.

In particular, in order to maintain the single phase of the perovskite, it is preferable to have a tolerance factor (t) value between 0.75 and 1, as in the equation below, and since the ionic radius difference (Ti⁴⁺0.64 Å, Ru⁴⁺0.62 Å) with the active material Ru to be doped in the Ti site is about 3.1%, which is very small compared to the size difference of 15 to 20% for general solid solution formation, the single phase of A_{1-y}A′_{y}Ti₁₋ₓRuₓO₃ can be maintained, which can be confirmed by XRD analysis.

$$t = ( {r}_{A or A '} + {r}_{O} ) / \{ √ 2 ( {r}_{Ti or Ru} + {r}_{O} ) \} > 0.75$$

In the A_{1-y}A′_{y}Ti₁₋ₓRuₓO₃ catalyst having the single phase perovskite structure, which has been manufactured in this way, the Ru nanoparticles can be uniformly exsoluted onto the catalyst surface by additionally heat-treating the catalyst under specific conditions, that is, under a high-temperature reducing atmosphere in the range of 600 to 1,200° C. In this case, the single phase homogeneous form changes into a multi-phase heterogeneous catalyst in the form of ruthenium metal nanoparticles+oxide catalyst, but has a catalyst structure that is distinguished from the conventional multi-phase heterogeneous catalyst. That is, the conventional catalyst is in the form of metal particles dispersed on an oxide or other metal support, but the catalyst according to the present disclosure is a catalyst of a perovskite structure in the form of ruthenium nanoparticles uniformly exsoluted on the catalyst surface. In particular, the ruthenium nanoparticles exsoluted onto the surface are anchored inside the crystal lattice in a form that is exsoluted from the perovskite crystal lattice, so not only is their resistance to sintering far superior to that of general dispersed catalysts, but since the exsoluted phenomenon occurs in the form of atoms or ions inside the crystal lattice, it has the effect of maximizing catalytic activity by ensuring nano-form and uniformity.

The present disclosure provides a catalyst with a perovskite structure represented by A_{1-y}A′_{y}Ti₁₋ₓRuₓO₃, which is a homogeneous catalyst having a perovskite single phase in which the A site is composed of Sr, Ca, or a combination thereof, the A′ site is doped with La, Y, or a combination thereof, and some of the Ti sites are doped with Ru, and which is heat-treated at 600 to 1,200° C. under a reducing atmosphere to exsolute uniform Ru nanoparticles on the surface of the catalyst. In this case, the Ti exsoluted together exists in the form of TiO₂ oxide on the surface of the catalyst to suppress the sintering phenomenon of Ru nanoparticles existing in a metallic state in a reforming reaction, thereby maximizing thermal stability and enabling a reforming reaction at a higher temperature due to high thermal stability even at high temperatures.

In Chemical Formula 1 above, the reason why the maintenance of the single phase of the perovskite is important is because it affects the process of exsoluting ruthenium nanoparticles onto the catalyst surface by performing a second heat treatment under a high-temperature reducing atmosphere after manufacturing the catalyst of Chemical Formula 1 above. That is, if the single phase of the perovskite as in Chemical Formula 1 above is not maintained, it is difficult to uniformly exsolute ruthenium nanoparticles onto the catalyst surface during the second heat treatment under a high-temperature reducing atmosphere, and thus the catalytic activity decreases.

The catalyst structurally maximizes thermal stability and reforming reaction sites, and can be used as a steam reforming (S/C<2) and dry reforming catalyst which are superior in suppressing carbon deposition. While the conventional catalysts show a decline in catalytic activity in dry reforming over several to several tens of hours due to a decrease in catalytic activity caused by carbon deposition, the catalyst according to the present disclosure has the effect of providing stable activity for more than 1,000 hours and a deterioration rate of less than 1%/1,000 hours in a dry reforming experiment.

In an exemplary embodiment, the catalyst may be prepared by a pechini method or a solid state mixing method.

In an exemplary embodiment, the catalyst may include 0.1 to 50% by weight of Ru based on the total weight of the catalyst. For example, when x in the above formula is 0.2, the Ru content is about 10% by weight. In another exemplary embodiment, the catalyst can contain Ru in an amount of 0.1% by weight or more, 0.5% by weight or more, 1% by weight or more, 2% by weight or more, 3% by weight or more, 4% by weight or more, 5% by weight or more, 6% by weight or more, 7% by weight or more, 8% by weight or more, 9% by weight or more, 10% by weight or more, 15% by weight or more, or 20% by weight or more, and 50% by weight or less, 45% by weight or less, 40% by weight or less, 35% by weight or less, 30% by weight or less, 25% by weight or less, 20% by weight or less, 15% by weight or less, 10% by weight or less, 9% by weight or less, 8% by weight or less, 7% by weight or less, 6% by weight or less, 5% by weight or less, 4% by weight or less, 3% by weight or less, 2% by weight or less, or 1% by weight or less, based on the total weight of the catalyst. The above catalyst can provide excellent catalytic activity even with a low content of Ru. In addition, when the catalyst contains Ru exceeding 20% by weight, there may be little difference in catalytic activity depending on the addition of Ru doping amount. Therefore, in terms of efficiency, it may be preferable that the catalyst contains 0.1 to 15% by weight or 0.1 to 10% by weight of Ru based on the total weight of the catalyst.

In an exemplary embodiment, in the above formula, A may be Sr and A′ may be La, or A may be Ca and A′ may be Y.

In an exemplary embodiment, in the above formula, A may have an ionic radius difference of 20% or less with respect to the A′ doping material.

In an exemplary embodiment, in the above formula, x may be greater than 0 and less than or equal to 0.3 or less than or equal to 0.2, since a minimum doping amount may be preferable.

In an exemplary embodiment, in the above formula, y may be greater than 0 and less than or equal to 0.5.

Preferably, the x may be greater than 0 and less than or equal to 0.3, and y may be greater than 0 and less than or equal to 0.5. Even in the range where both the x and y are greater than 0 and less than or equal to 0.5, single phase can be maintained, but in particular, in terms of carbon deposition mitigation and reforming performance, it may provide excellent effects when the y value does not exceed 0.5 and the x value does not exceed 0.3. This is also preferable in order to reduce the catalyst cost burden.

In an exemplary embodiment, the catalyst may be for steam reforming. For example, the catalyst may be suitable for steam reforming with a small steam supply ratio.

In an exemplary embodiment, the steam/carbon (S/C) ratio in the steam reforming may be less than or equal to 2.

In an exemplary embodiment, the catalyst may be for dry reforming.

In an exemplary embodiment, the catalyst may be for dry reforming of biogas.

Biogas is a gaseous fuel that can be produced by anaerobic digestion, gasification, or pyrolysis of biomass such as sewage sludge and food waste. Such biogas may contain methane (about 55 to 70%) and carbon dioxide (about 30 to 45%) as main components, and may contain impurities such as sulfur(S). In an exemplary embodiment, the biogas may contain methane and/or carbon dioxide.

In an exemplary embodiment, the catalyst may be for dry reforming of methane and/or carbon dioxide. For example, the catalyst has the effect of suppressing carbon deposition and having excellent long-term thermal stability in a dry reforming reaction that produces synthesis gas (CO and H₂) using methane and carbon dioxide.

In the present disclosure, dry reforming may mean a reaction that produces carbon monoxide and hydrogen from carbon dioxide and methane.

In this regard, among reforming processes for converting methane, which is used as fuel for high-temperature fuel cells, into hydrogen, the dry reforming is useful in terms of recycling carbon dioxide and using less energy compared to the steam reforming, and has endothermic properties that help cool the fuel cell power generation system. For reference, Reaction Formula 1 below is a reaction formula for the dry reforming reaction of carbon dioxide.

CH₄+CO₂→2CO+2H₂,ΔH⁰₂₉₈=247KJ/mol [Reaction Formula 1]

This dry reforming reaction thermodynamically shows a higher conversion rate and a larger yield of hydrogen or carbon monoxide at higher temperatures, but conventional nickel-based catalysts, for example, show problems of deactivation due to sintering and aggregation and carbon deposition under operating conditions, especially 700° C. or less. On the other hand, the perovskite-based catalyst according to the present disclosure hardly shows problems of deactivation due to sintering of the catalyst or carbon deposition even at high temperatures, and has a technical advantage of no carbon deposition at 700° C. or less.

Therefore, the catalyst of the present disclosure can be usefully used as a reforming catalyst for a fuel cell, especially a high-temperature fuel cell, that performs direct and indirect reforming reactions of carbon dioxide. In addition, a high-temperature fuel cell using the catalyst of the present disclosure can be stably operated for a long time under dry reforming conditions.

In another aspect, the present disclosure provides a method for preparing the catalyst with the perovskite structure, and the method is a method for manufacturing a metal nanoparticle exsolution catalyst with the perovskite structure, comprising preparing a mixture of a metal precursor solution; drying and calcining the mixture; and heat-treating the mixture under a reducing atmosphere at 600 to 1,200° C. after the calcination.

In an exemplary embodiment, the drying may be performed at 70 to 90° C.

In an exemplary embodiment, the drying may be performed for 60 to 180 minutes.

In an exemplary embodiment, the calcination may be performed at 600 to 800° C.

In an exemplary embodiment, the calcination may be performed for 60 to 180 minutes.

In an exemplary embodiment, the heat treatment for nanoparticle exsolution after the calcination may be performed under a reducing atmosphere at 600 to 1,200° C. for 60 to 600 minutes.

In still another aspect, the present disclosure provides a dry reforming method using the catalyst with the perovskite structure, which includes supplying a reaction raw material gas containing methane and/or carbon dioxide to a reactor containing the catalyst with the perovskite structure to perform a dry reforming reaction.

Unlike the steam reforming, the dry reforming uses carbon dioxide as a gas, so energy consumption is less than the steam reforming that injects water, and thus has small difference in efficiency according to the amount of carbon dioxide injected. In an exemplary embodiment, the reaction raw material gas may be a mixture of methane and carbon dioxide at a molar ratio of 1:1 or more, 1:1 to 10, 1:1 to 5, or 1:1 to 3. In order to control the flow rate of the reaction gas, an inert gas such as nitrogen (N₂) or argon (Ar) may be used in a diluted manner. The present disclosure has an effect of providing an excellent conversion rate of methane even when the amount of carbon dioxide supplied increases.

In an exemplary embodiment, the dry reforming reaction may be performed at a weight hourly space velocity (WHSV) of 100 to 300 L/(h·g_{cat}).

In an exemplary embodiment, the dry reforming reaction may be performed at 600 to 900° C.

In an exemplary embodiment, the dry reforming reaction may be performed for 1 hour or more, 100 hours or more, 500 hours or more, 1,000 hours or more, 1,500 hours or more, 2,000 hours or more, 1 to 2,000 hours, 1 to 1,500 hours, or 1 to 1,000 hours.

The dry reforming method according to the present disclosure has the effect of providing stable dry reforming performance without carbon deposition during operation at 600 to 900° C. for 1,000 hours or more. For example, it can show a conversion rate of methane about 98% or more and a conversion rate of carbon dioxide of about 99% or more at operation at 900° C., and it can show a conversion rate of methane of 93% and a conversion rate of carbon dioxide of 91%, which are close to the thermodynamic equilibrium value, even at operation at 700° C.

Hereinafter, the present disclosure will be described in more detail through Examples. It will be apparent to those skilled in the art that these Examples are intended only to illustrate the present disclosure, and the scope of the present disclosure is not to be construed as being limited by these Examples.

### Example 1. Preparation of SLT-Ru Catalyst

In this Example, perovskite single-phase powder of Sr_{0.92}La_{0.08}Ti_{0.95}Ru_{0.05}O₃, in which in the A_{1-y}A′_{y}Ti₁₋ₓRuₓO₃ structure, the A site is composed of Sr, the A′ site is doped with La, and some of the Ti sites are doped with Ru, was prepared using a citric acid method as follows.

To prepare 5 g of the SLT-Ru catalyst, 0.91 g of lanthanum nitrate hydrate [La(NO₃)₃·xH₂O], 5.12 g of strontium nitrate hydrate [Sr(NO₃)₃·xH₂O], and 5 g of citric acid were simultaneously dissolved in 50 mL of deionized water (DI water). 7.10 g of titanium isopropoxide {Ti[OCH(CH₃)₂]₄} and 0.34 g of ruthenium chloride hydrate (RuCl₃·xH₂O) were dissolved in 5 mL of ethylene glycol [C₂H₅O₂] for stabilization. Each solution was mixed together for 24 hours, dried at 80° C., and calcined in air at 650° C. After the formation of a perovskite single phase was confirmed through XRD analysis, it was heat-treated at 900° C. for 2 hours under a reducing atmosphere (10% H₂₊₉₀% N₂) to finally obtain the dry deforming catalyst of Sr_{0.92}La_{0.08}Ti_{0.95}Ru_{0.05}O₃ (hereinafter referred to as SLT-Ru). The Ru usage of this catalyst was 2.66% by weight.

### Example 2. Preparation of CYT-Ru Catalyst

In this Example, a perovskite single phase powder of Ca_{0.92}Y_{0.08}Ti_{0.95}Ru_{0.05}O₃, in which in the A_{1-y}A′_{y}Ti₁₋ₓRuₓO₃ structure, the A site is composed of Ca, the A′ site is doped with Y, and some of the Ti sites are doped with Ru, was prepared using a citric acid method as follows.

To prepare 5 g of the CYT-Ru catalyst, 1.07 g of yttrium nitrate hydrate [Y(NO₃)₃·xH₂O], 7.62 g of calcium nitrate hydrate [Ca(NO₃)₃·xH₂O], and 5 g of citric acid were simultaneously dissolved in 50 mL of deionized water (DI water). 9.47 g of titanium isopropoxide {Ti[OCH(CH₃)₂]₄} and 0.36 g of ruthenium chloride hydrate (RuCl₃·xH₂O) were dissolved in 5 mL of ethylene glycol [C₂H₅O₂] for stabilization. Each solution was mixed together for 24 hours, dried at 80° C., and calcined in air at 650° C. After the formation of a perovskite single phase was confirmed through XRD analysis, it was heat-treated at 900° C. for 2 hours under a reducing atmosphere (10% H₂+90% N₂) to finally obtain a dry reforming catalyst of Ca_{0.92}Y_{0.08}Ti_{0.95}Ru_{0.05}O₃ (hereinafter referred to as CYT-Ru). The Ru usage of this catalyst was 3.55% by weight.

### Comparative Example 1. Preparation of SLT Catalyst

Unlike the catalyst of Example 1 above, a catalyst with x=0, y=0.08 that was not doped with ruthenium (i.e., Sr_{0.92}La_{0.08}TiO₃; hereinafter referred to as SLT) was prepared by a citric acid method as follows.

To prepare 5 g of an SLT catalyst, 0.92 g of lanthanum nitrate hydrate [La(NO₃)₃·xH₂O], 5.19 g of strontium nitrate hydrate [Sr(NO₃)₃·xH₂O], and 7.57 g of titanium isopropoxide {Ti[OCH(CH₃)₂]₄} were mixed in 50 mL of deionized water, and 5 mL of ethylene glycol [C₂H₅O₂] and 5 g of citric acid were added to prepare a nitrate aqueous solution, which was dried at 80° C. and calcined at 650° C. in air. Finally, the catalyst was prepared by heat-treating at 900° C. for 2 hours under a reducing atmosphere (10% H₂₊₉₀% N₂).

### Comparative Example 2. Preparation of Ru/SLT Catalyst

Unlike the catalyst of the above Example 1, a catalyst in which 3% by weight of ruthenium was loaded on Sr_{0.92}La_{0.08}TiO₃ prepared in Comparative Example 1 without doping ruthenium (i.e., 3% by weight of Ru/Sr_{0.92}La_{0.08}TiO₃; hereinafter referred to as Ru/SLT) was prepared by an impregnation method as follows.

A mixture of 5 g of Sr_{0.92}La_{0.08}TiO₃ support, 0.28 g of ruthenium chloride hydrate (RuCl₃·xH₂O), and 50 mL of deionized water (DI water) was stirred at room temperature for 6 hours and dried at 80° C. using a rotary evaporator. The dried powder was calcined at 650° C. in air and heat-treated at 900° C. for 2 hours under a reducing atmosphere (10% H₂+90% N₂). When the total weight of Sr_{0.92}La_{0.08}TiO₃ and ruthenium was 100%, a catalyst was obtained in which ruthenium was impregnated on the catalyst surface at 3.0% by weight.

### Comparative Example 3. Preparation of SCT-Ru Catalyst

In this Comparative Example, a perovskite single-phase powder of Sr_{0.92}Ca_{0.08}Ti_{0.95}Ru_{0.05}O₃, in which in the A_{1-y}A′_{y}Ti₁₋ₓRuₓO₃ structure, the A site is composed of Sr, the A′ site is doped with Ca, and some of the Ti sites are doped with Ru, was prepared using a citric acid method as follows.

To prepare 5 g of the SCT-Ru catalyst, 0.52 g of calcium nitrate hydrate [Ca(NO₃)₃·xH₂O], 5.34 g of strontium nitrate hydrate [Sr(NO₃)₃·xH₂O], and 5 g of citric acid were simultaneously dissolved in 50 mL of deionized water (DI water). 7.40 g of titanium isopropoxide {Ti[OCH(CH₃)₂]₄} and 0.28 g of ruthenium chloride hydrate (RuCl₃·xH₂O) were dissolved in 5 mL of ethylene glycol [C₂H₅O₂] for stabilization. Each solution was mixed together for 24 hours, dried at 80° C., and calcined in air at 650° C. After the formation of a perovskite single phase was confirmed through XRD analysis, it was heat-treated at 900° C. for 2 hours under a reducing atmosphere (10% H₂+90% N₂), to finally obtain a dry reforming catalyst of Sr_{0.92}Ca_{0.08}Ti_{0.95}Ru_{0.05}O₃ (hereinafter referred to as SCT-Ru). The Ru usage of this catalyst was 2.77% by weight.

### Comparative Example 4. Preparation of SBT-Ru Catalyst

In this Comparative Example, a perovskite single-phase powder of Sr_{0.92}Ba_{0.08}Ti_{0.95}Ru_{0.05}O₃, in which the A_{1-y}A′_{y}Ti₁₋ₓRuₓO₃ structure, the A site is composed of Sr, the A′ site is doped with Ba, and some of the Ti sites are doped with Ru, was prepared using a citric acid method as follows.

To prepare 5 g of the SBT-Ru catalyst, 0.55 g of barium nitrate hydrate [Ba(NO₃)₃·xH₂O], 5.12 g of strontium nitrate hydrate [Sr(NO₃)₃·xH₂O], and 5 g of citric acid were simultaneously dissolved in 50 mL of deionized water (DI water). 7.10 g of titanium isopropoxide {Ti[OCH(CH₃)₂]₄} and 0.27 g of ruthenium chloride hydrate (RuCl₃·xH₂O) were dissolved in 5 mL of ethylene glycol [C₂H₅O₂] for stabilization. Each solution was mixed together for 24 hours, dried at 80° C., and calcined in air at 650° C. After the formation of a perovskite single phase was confirmed through XRD analysis, it was heat-treated at 900° C. for 2 hours under a reducing atmosphere (10% H₂₊₉₀% N₂) to finally obtain a dry forming catalyst of Sr_{0.92}Ba_{0.08}Ti_{0.95}Ru_{0.05}O₃ (hereinafter referred to as SBT-Ru). The Ru usage of this catalyst was 2.66% by weight.

### Comparative Example 5. Preparation of SYT-Ru Catalyst

In this Comparative Example, a perovskite single-phase powder of Sr_{0.92}Y_{0.08}Ti_{0.95}Ru_{0.05}O₃, in which in the A_{1-y}A′_{y}Ti₁₋ₓRuₓO₃ structure, the A site is composed of Sr, the A′ site is doped with Y, and some of the Ti sites are doped with Ru, was prepared using a citric acid method as follows.

To prepare 5 g of SYT-Ru catalyst, 0.82 g of yttrium nitrate hydrate [Y(NO₃)₃·xH₂O], 5.23 g of strontium nitrate hydrate [Sr(NO₃)₃·xH₂O], and 5 g of citric acid were simultaneously dissolved in 50 mL of deionized water (DI water). 7.25 g of titanium isopropoxide {Ti[OCH(CH₃)₂]₄} and 0.28 g of ruthenium chloride hydrate (RuCl₃·xH₂O) were dissolved in 5 mL of ethylene glycol [C₂H₅O₂] for stabilization. Each solution was mixed together for 24 hours, dried at 80° C., and calcined in air at 650° C. After the formation of a perovskite single phase was confirmed through XRD analysis, it was heat-treated at 900° C. for 2 hours under a reducing atmosphere (10% H₂+90% N₂) to finally obtain a dry reforming catalyst of Sr_{0.92}Y_{0.08}Ti_{0.95}Ru_{0.05}O₃ (hereinafter referred to as SYT-Ru). The Ru usage of this catalyst was 2.71% by weight.

### Experimental Example 1. XRD (X-Ray Diffraction) Analysis

XRD diffraction analysis was performed using a diffractometer from Rigaku (RINT-5200 model, Rigaku). The samples were measured at 2θ=20° to 80°.

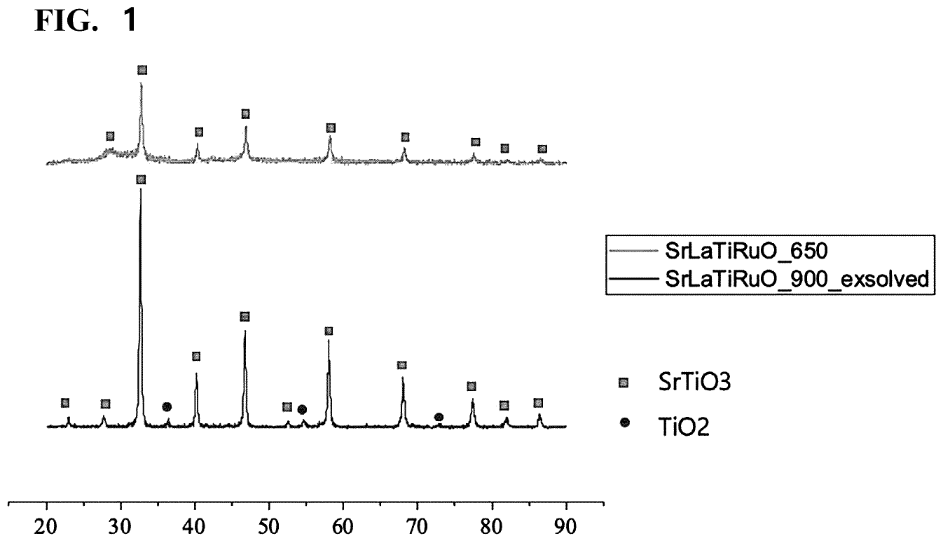

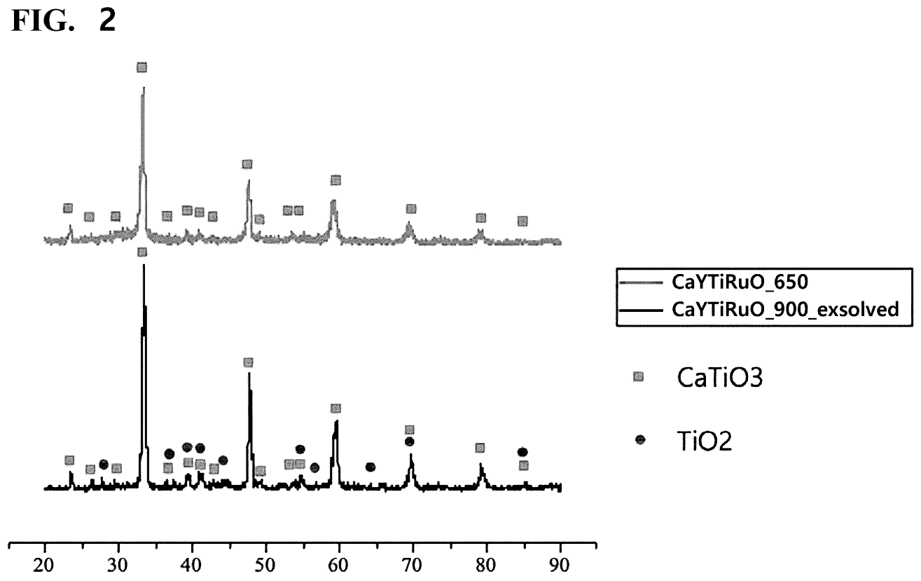

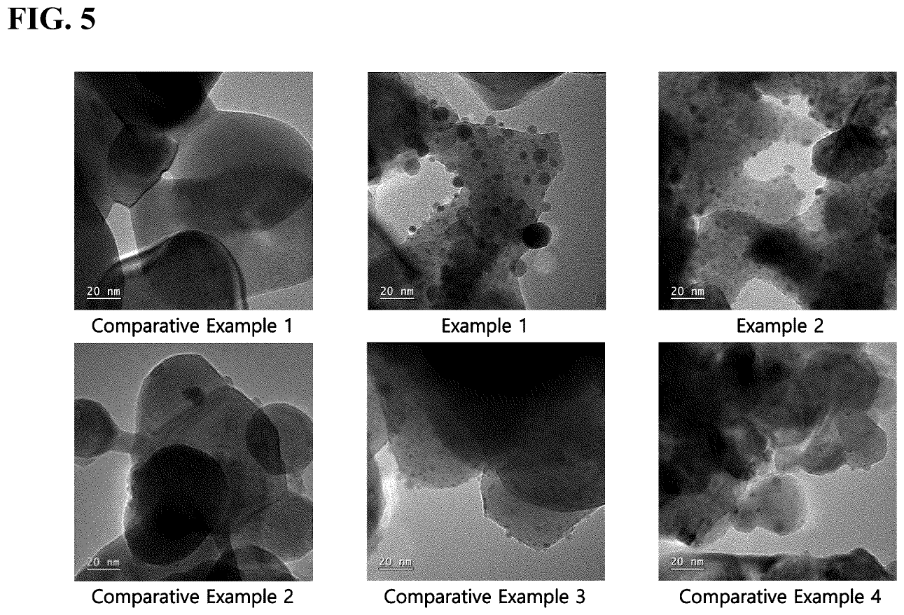

FIG. 1 shows XRD graphs of the catalyst of Example 1, and FIG. 2 shows XRD graphs of the catalyst of Example 2 after calcination at 650° C. and after exsolution process for 2 hours under a reducing atmosphere at 900° C., respectively. It was confirmed that a homogeneous catalyst having a perovskite single phase was formed after calcination at 650° C. Even after exsolution process for 2 hours under a reducing atmosphere at 900° C., the perovskite structure was maintained, but some TiO₂ oxide was observed and Ru was not observed. However, considering the TEM images of the catalysts of Example 1 (SLT-Ru) and Example 2 (CYT-Ru) in FIG. 5, it can be confirmed that a large number of Ru nanoparticles were formed on the catalyst surface. The fact that Ru was not identified in the XRD analysis results is determined to be due to the small doping amount of approximately 2.66% by weight.

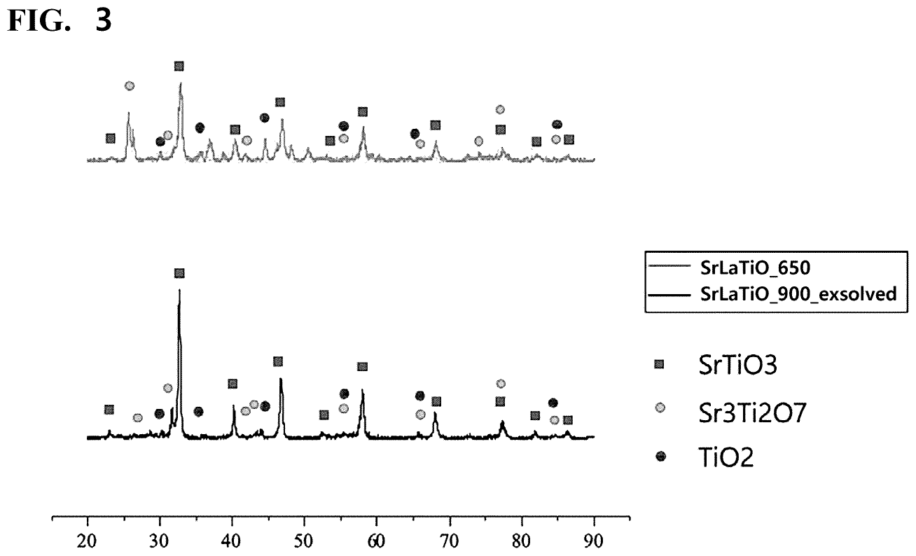

FIG. 3 shows XRD graphs of the catalysts of Comparative Example 1 after calcination at 650° C. and after an exsolution process for 2 hours under a reducing atmosphere at 900° C., respectively. After calcination at 650° C., the catalyst of Comparative Example 1 (SLT) was confirmed to have a mixed phase of the Ruddlesen-Popper (RP, Sr₂TiO₄) structure in which in the ABO₃ structure, the Ti at the B site exists as TiO₂ oxide while the B site and the oxygen site are lacking, and the perovskite SrTiO₃ structure. However, as shown in the lower graph of FIG. 3, after an exsolution process for 2 hours under a reducing atmosphere at 900° C., the RP structure was reduced and the perovskite SrTiO₃ structure was found to be the majority. Considering the TEM image after the exsolution process for the catalyst of Comparative Example 1 (SLT) in FIG. 5, it can be seen that, unlike the catalysts of Examples 1 (SLT-Ru) and 2 (CYT-Ru), no exsoluted nanoparticles were formed on the surface. This is because the catalyst of Comparative Example 1 (SLT) was not doped with Ru, and it can be confirmed that the TiO₂ oxide observed in FIGS. 1 to 3 is not the protrusion-shaped nanoparticles that appear on the catalyst surface in Examples 1 and 2 of FIG. 5.

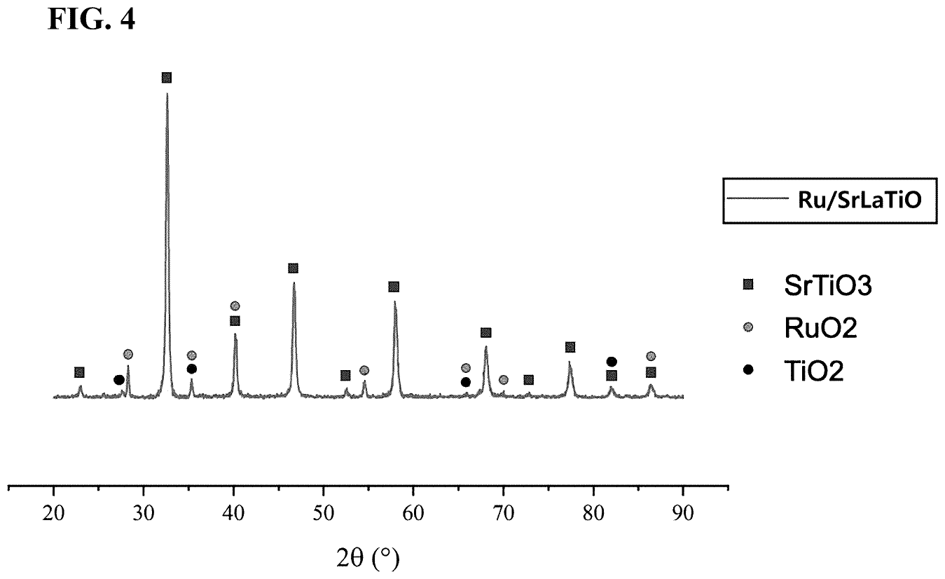

FIG. 4 shows an XRD graph for the catalyst of Comparative Example 2 (Ru/SLT). In the case of the Ru/SLT catalyst in which 3% by weight of Ru was impregnated into the SLT oxide support of Comparative Example 1, a low-intensity RuO₂ peak was observed even after calcination at 650° C. It is determined that this was detected in the XRD analysis because Ru exists as large particles on the surface of the SLT support or separately, as in the TEM image of the catalyst of Comparative Example 2 (Ru/SLT) in FIG. 5. Therefore, among the catalyst samples to which Ru was added, Ru was observed in both the XRD and TEM analyses only in the case of Comparative Example 2. In Examples 1 and 2, it was confirmed that Ru nanoparticles were observed only in the TEM analysis after the exsolution process under a reducing atmosphere. Among all the catalyst samples, the catalysts in the form of exsoluted Ru nanoparticles were found to be Examples 1 and 2, which included Sr and La or Ca and Y, maintained the perovskite single phase after calcination, and then performed the exsolution process under a reducing atmosphere. In the case where the A site was composed of Sr and the A′ site was substituted with Ca or Ba, as in the catalysts of Comparative Examples 3 and 4, exsoluted Ru nanoparticles were observed, but the number of Ru nanoparticles was significantly smaller than that of the catalysts of Examples 1 and 2 (see FIG. 5).

As described above, in the XRD analysis results of FIGS. 1 and 2, both catalysts of Examples 1 and 2 formed a perovskite single phase before high-temperature reduction treatment, but when exsolution was performed through high-temperature reduction treatment, TiO₂ oxide was observed. When ABO₃ perovskite oxide is subjected to high-temperature reduction treatment, the cations at the B site are exsoluted to form BO₂ oxide, and in this case, the conventional perovskite ABO₃ structure changes to the A₂BO₄ Ruddlesden-popper structure, which is a pseudo-perovskite structure. Therefore, Ti and Ru at the B site are exsoluted under a reducing atmosphere, respectively, and TiO₂ exists on the surface in the form of oxide and Ru exists on the surface in the form of metal particles. In the catalysts of Examples 1 and 2, Ru with a small doping amount was not detected in the XRD analysis, but as shown in FIG. 5, it was confirmed in the TEM image that many Ru nanoparticles were formed on the catalyst surface. In addition, in the catalysts of Examples 1 and 2, after the exsolution process was conducted under a reducing atmosphere at 900° C., the RP structure as in FIG. 3 of the catalyst of Comparative Example 1 (SLT) could not be observed in the XRD analysis because only a part of the catalyst surface became the RP structure and most of the core part maintained the conventional perovskite structure.

### Experimental Example 2. TEM Analysis

The catalysts obtained by high-temperature reduction treatment in Examples 1 and 2 and Comparative Examples 1 to 4 were observed using a transmission electron microscope (TEM, Tecnai F20, FEI) and are shown in FIG. 5.

The catalyst of Comparative Example 1 (SLT) was found to not form nanoparticles exsoluted on the surface.

As shown in FIG. 5, it was confirmed that a large number of Ru nanoparticles were formed on the surface of the catalysts of Example 1 (SLT-Ru) and Example 2 (CYT-Ru). The EDAX analysis results for the nanoparticles of the catalysts of Example 1 and Example 2 also confirmed that the main component of the nanoparticles was Ru, confirming that a large number of nanoparticles in the catalysts of Example 1 and Example 2 were Ru exsoluted from within the perovskite crystal lattice.

The catalyst of Comparative Example 2 (Ru/SLT) is a catalyst in which Ru particles are dispersed on the surface of Comparative Example 1 (SLT) by an impregnation method. Since large Ru particles of several hundred nanometers in size were formed on the surface from the beginning of catalyst production, it was difficult to observe the formation of additional nanoparticles after the exsolution process. Therefore, the TEM image of the catalyst surface of Comparative Example 2 confirmed in FIG. 5 was significantly different from the form in which nanoparticles were uniformly formed on the surface of the catalyst particles after the exsolution process, as in the catalysts of Examples 1 and 2.

In particular, in the catalysts of Examples 1 and 2, Ru could not be observed in the XRD analysis after the exsolution process under a high-temperature reducing atmosphere due to the small doping amount of Ru (approximately 2.66% by weight). However, it was confirmed through the TEM image of FIG. 5 that countless Ru nanoparticles were exsoluted on the surface. In addition, as shown in Comparative Examples 3 and 4, the catalysts of SCT-Ru and SBT-Ru, in which the A site is composed of Sr and the A′ site is substituted with Ca or Ba, showed significantly less exsoluted Ru nanoparticles than those of the catalysts of Examples 1 (SLT-Ru) and 2 (CYT-Ru), as confirmed in the images of Comparative Examples 3 and 4 in FIG. 5.

From these results, it was confirmed in the catalysts of Examples 1 and 2 that a perovskite single phase was maintained after calcination at 650° C., and after heat treatment at 900° C. for 2 hours under a reducing atmosphere, a large number of ruthenium nanoparticles were uniformly exsoluted on the catalyst surface as shown in FIG. 5, thereby maximizing not only the structural thermal stability but also the active sites for the dry reforming reaction, thereby maximizing the conversion rate of methane and carbon dioxide.

### Experimental Example 3. Dry Reforming Reaction

To measure the high-temperature activity, methane dry reforming was performed using the catalysts of Examples 1 and 2 and Comparative Examples 1 to 4 in a fixed-bed continuous flow system under atmospheric pressure.

A quartz tube (inner diameter of 2 mm) was used as an out-of-cell reactor. Each catalyst (20 mg) was placed on quartz wool in the middle of the reactor. Before measurement, each catalyst was further reduced in situ under a diluted hydrogen gas (10% H₂/Ar) flow at 900° C. for 2 hours, and then reforming experiments were performed.

The temperature of the reforming experiment was 600 to 900° C., and the reforming reaction at each measurement temperature was maintained for 90 minutes, and the conversion rate of methane was measured. The composition of the raw material gas used for reforming was CH₄/CO₂/N₂ (flow molar ratio was 20 sccm/20 sccm/40 sccm). A weight hourly space velocity (WHSV) (which is the mass flow of reactants divided by the mass of catalyst) was 120 L/(h·g_{cat}).

The reactants were analyzed using a gas chromatograph (GC, Agilent 6900 model) equipped with a TCD detector. The conversion rates of methane and carbon dioxide were calculated by the following equation.

$${CH}_{4 , conversion rate} = [ ( {CH}_{4 , i n} - {CH}_{4 , out} ) / {CH}_{4} , in ] \times 100 \\ {CO}_{2 , conversion rate} = [ ( {CO}_{2 , i n} - {CO}_{2 , out} ) / {CO}_{2} , in ] \times 100$$

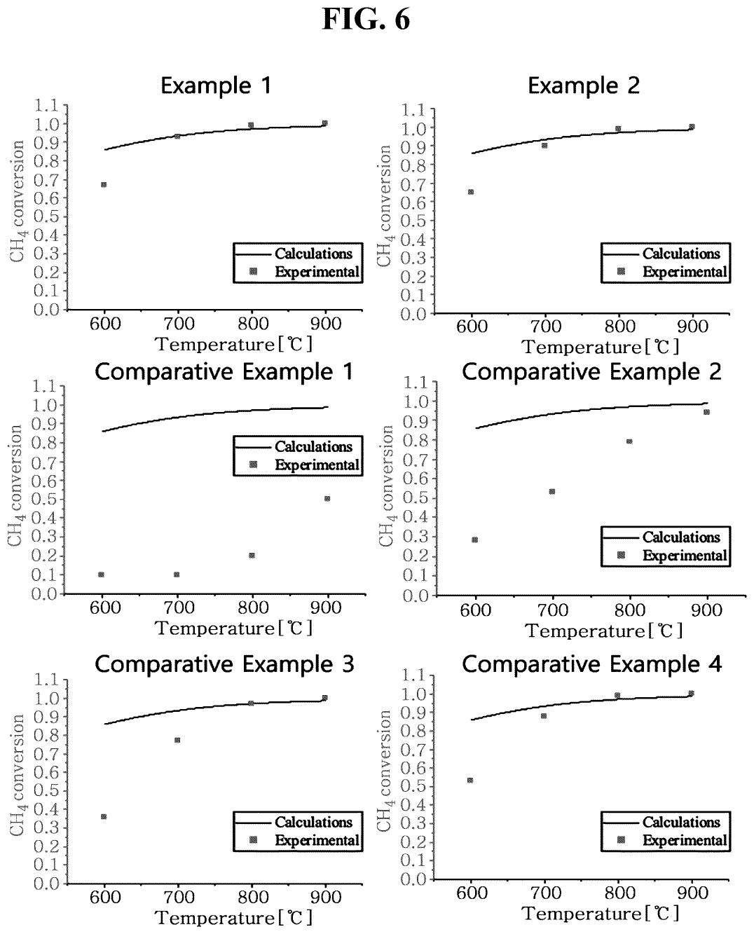

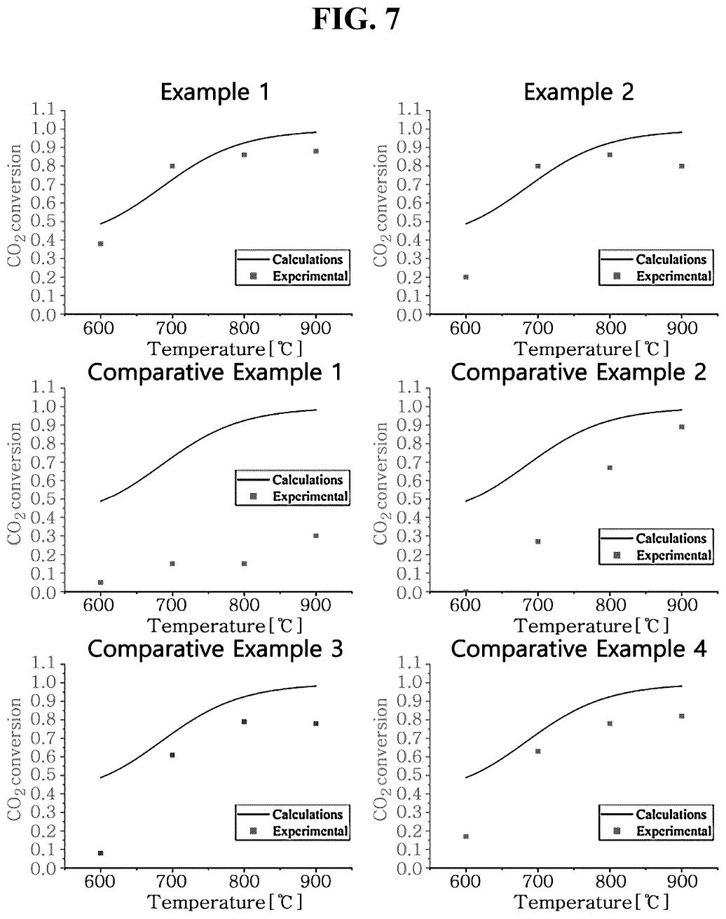

FIG. 6 shows the conversion rate (%) of methane by temperature during dry reforming operation after reduction treatment for the catalysts of Example 1, Example 2, Comparative Example 1, Comparative Example 2, Comparative Example 3, and Comparative Example 4. FIG. 7 shows the conversion rate (%) of carbon dioxide by temperature during dry reforming operation after reduction treatment for the catalysts of Example 1, Example 2, Comparative Example 1, Comparative Example 2, Comparative Example 3, and Comparative Example 4. In FIGS. 6 and 7, the x-axis represents temperature (° C.), and the y-axis represents the conversion rate (%) of methane and the conversion rate (%) of carbon dioxide, respectively.

As confirmed in FIG. 6, the catalysts of Example 1 (SLT-Ru) and Example 2 (CYT-Ru) showed a conversion rate of methane of about 99% or more, which is close to the thermodynamic equilibrium value (solid line) at a temperature of 800° C. or higher. The catalyst of Example 1 (SLT-Ru) showed a conversion rate of methane of 93% at 700° C., and the catalyst of Example 2 (CYT-Ru) showed a conversion rate of methane of 90% at 700° C., confirming that the catalyst of Example 1 exhibited a better conversion rate (%) of methane at low temperatures. Meanwhile, the catalysts of Comparative Example 3 (SCT-Ru) and Comparative Example 4 (SBT-Ru) showed higher conversion performance of methane than that of the catalysts of Comparative Example 1 (SLT) and Comparative Example 2 (Ru/SLT), but the conversion rate of methane was lower than that of the catalysts of Examples 1 and 2.

The conversion rate of the carbon dioxide in FIG. 7 was also similar, as shown in FIG. 6, showing that the catalysts of Examples 1 and 2 exhibited superior conversion rate of carbon dioxide compared to those of the other catalysts. In particular, the catalyst of Example 1 (SLT-Ru) showed a high conversion rate of carbon dioxide close to the thermodynamic equilibrium value (solid line) at all operating temperatures. This is determined to be because in the perovskite structure the A site was composed of Sr and the A′ site was doped with La, thereby obtaining high catalytic activity in the dry reforming reaction.

In FIGS. 6 and 7, the catalyst of Comparative Example 1 (SLT) and the catalyst of Comparative Example 2 (Ru/SLT) showed very low conversion rate (%) of methane and conversion rate (%) of carbon dioxide compared to those of the other catalysts. In the case of the catalyst of Comparative Example 1 (SLT), it showed the lowest activity in the dry reforming reaction, which showed that the presence or absence of Ru plays a very important role in the dry reforming reaction activity. In the case of the catalyst of Comparative Example 2 (Ru/SLT), it showed very low catalytic activity compared to the catalyst of Example 1 (SLT-Ru) and the catalyst of Example 2 (CYT-Ru), which contained Ru nanoparticles at the remaining operating temperatures (600 to 800° C.) except for a high temperature of 900° C. or higher. From this, it was found that even if a catalyst contains the same amount of Ru, it showed a very large difference in catalytic activity depending on the catalyst structure, as can be seen in the TEM image of FIG. 5. In addition, when comparing the conversion rates of methane and carbon dioxide for the catalysts of Comparative Example 3 (SCT-Ru) and Comparative Example 4 (SBT-Ru) with those of Examples 1 and 2, it was found that the number of exsoluted Ru nanoparticles confirmed in FIG. 5 had a very significant effect on the dry reforming catalyst performance.

### Experimental Example 4. Long-Term Dry Reforming Reaction

According to the methane dry reforming reaction method described in Experimental Example 3 above, a long-term reaction was performed at 700° C. for 1,000 hours. The catalysts used were the catalyst of Example 1 (SLT-Ru), the catalyst of Comparative Example 2 (Ru/SLT), the catalyst of Comparative Example 5 (SYT-Ru), and a commercial catalyst (Ni/Al₂O₃). The commercial catalyst was obtained from Clariant AG® and used.

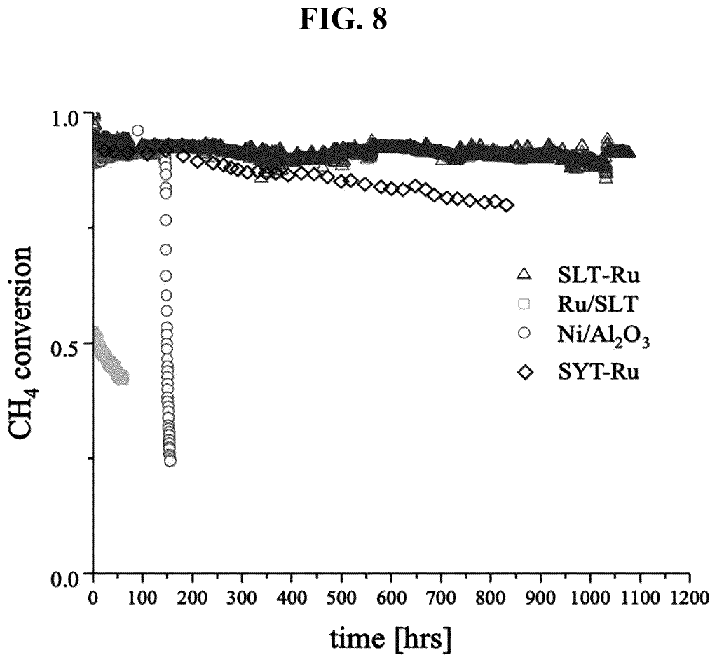

FIG. 8 shows the results of a long-term dry reforming experiment. In FIG. 8, the X-axis represents time (h), and the Y-axis represents the conversion rate (%) of methane. The catalyst of Comparative Example 5 (SYT-Ru), in which in the perovskite structure, the A site was composed of Sr and the A′ site was doped with Y, showed a higher conversion rate of methane than that of the catalyst of Comparative Example 2 (Ru/SLT) or that of the commercial catalyst (Ni/Al₂O₃), but it was found to have lower long-term stability than that of the catalyst of Example 1 (SLT-Ru). In the case of the catalyst of Comparative Example 2 (Ru/SLT), the conversion rate of methane was found to decrease by about 20% or more during 20 hours of dry reforming at 700° C., and the conversion rate of methane fell to 40% or less within 100 hours. On the other hand, the catalyst of Example 1 (SLT-Ru) showed the conversion rate of methane of 91% or more even after 1,000 hours of operation, confirming that it provided the best conversion rate of methane (initial 93%) and deterioration rate (0.3%/1,000 hours) among previously reported dry reforming catalysts, especially at low temperature operation of 700° C., with a deterioration rate of 0.3%/1,000 hours. It was found that the catalyst of Example 1 maintained a very high conversion rate of methane with almost no performance decrease. Such high catalytic activity is attributed to the large number of Ru nanoparticles exsoluted on the surface of the perovskite catalyst, as can be seen in the TEM images of Examples 1 and 2 in FIG. 5. It was confirmed that the catalytic activity can be maximized through the process of exsoluting Ru nanoparticles under a reducing atmosphere after manufacturing a single-phase perovskite catalyst in which in the perovskite structure, the A site is composed of Sr and the A′ site is doped with La.

While the specific parts of the present disclosure have been described in detail, it will be apparent to those skilled in the art that such specific descriptions are merely preferred embodiments and do not limit the scope of the present disclosure. Accordingly, the substantial scope of the present disclosure is defined by the appended claims and their equivalents.

What is claimed is:

1. A catalyst with a perovskite structure,
wherein the catalyst is represented by Chemical Formula 1, and comprises Ru nanoparticle exsoluted onto a surface of the catalyst:
A_{1-y}A′_{y}Ti₁₋ₓRuₓO₃ [Chemical Formula 1]
wherein A is Sr, Ca, or a combination thereof, A′ is La, Y, or a combination thereof, x is greater than 0 and less than or equal to 0.5, and y is greater than 0 and less than 1.0.

2. The catalyst of claim 1, wherein the catalyst is a single phase homogeneous catalyst represented by the Chemical Formula 1.

3. The catalyst of claim 1, wherein the exsoluted Ru nanoparticle is formed by heat-treating a single phase homogeneous catalyst represented by the Chemical Formula 1 at 600 to 1,200° C. under a reducing atmosphere.

4. The catalyst of claim 1, wherein the catalyst comprises 0.1 to 50% by weight of Ru based on the total weight of the catalyst.

5. The catalyst of claim 1, wherein in the Chemical Formula 1, A is Sr and A′ is La, or A is Ca and A′ is Y.

6. The catalyst of claim 1, wherein in the Chemical Formula 1, x is greater than 0 and less than or equal to 0.3, and y is greater than 0 and less than or equal to 0.5.

7. The catalyst of claim 1, wherein the catalyst is for dry reforming of methane and/or carbon dioxide.
